(19) United States
(12) Patent Application Publication
(10) Pub. No.: US 2020/0349033 A1
(43) Pub. Date: Nov. 5, 2020

(54) METHOD AND SYSTEM FOR CHECKPOINT AND RESTART FOR DISTRIBUTED BACKUP STORAGE DEVICES

(71) Applicant: EMC IP Holding Company LLC, Hopkinton, MA (US)

(72) Inventors: Shelesh Chopra, Bangalore (IN); Jayashree B. Radha, Bangalore (IN); Sunil K. Yadav, Bangalore (IN); Manish Sharma, Bangalore (IN); Aaditya Rakesh Bansal, Bangalore (IN); Amit Jain, Bangalore (IN)

(21) Appl. No.: 16/402,309

(22) Filed: May 3, 2019

(51) Int. Cl. G06F 11/14

(52) U.S. Cl. CPC G06F 11/1469; G06F 2201/84; G06F 2201/82; G06F 11/1451

(57) ABSTRACT

A method for managing backup operations, the method including generating a checkpoint from an in-memory data structure maintained in a memory of a management device, where the in-memory data structure specifies a first plurality of backups, where each of the plurality of backups is stored in one of a second plurality of backup storage devices managed by the management device, persistently storing the checkpoint and after restarting the management device, rebuilding the in-memory data structure using the checkpoint to obtain a rebuilt in-memory data structure.

### BACKGROUND

Computing devices may generate data during their operation. For example, applications hosted by the computing devices may generate data used by the applications to perform their functions. Such data may be backed up and subsequently stored in persistent storage of backup storage devices. Failure or restarting of the computing devices that manage the backup storage devices may negatively impact the ability to restore applications using the backups.

### SUMMARY

Other aspects of the invention will be apparent from the following description and the appended claims.

In general, in one aspect, the invention relates to a method for managing backup operations, the method comprising generating a checkpoint from an in-memory data structure maintained in a memory of a management device, wherein the in-memory data structure specifies a first plurality of backups, wherein in each of the plurality of backups is stored in one of a second plurality of backup storage devices managed by the management device, persistently storing the checkpoint, and after restarting the management device, rebuilding the in-memory data structure using the checkpoint to obtain a rebuilt in-memory data structure.

In general, in one aspect, the invention relates to a non-transitory computer readable medium comprising computer readable program code, which when executed by a computer processor enables the computer processor to perform a method for storing data, the method comprising generating a checkpoint from an in-memory data structure maintained in a memory of a management device, wherein the in-memory data structure specifies a first plurality of backups, wherein in each of the plurality of backups is stored in one of a second plurality of backup storage devices managed by the management device, persistently storing the checkpoint, and after restarting the management device, rebuilding the in-memory data structure using the checkpoint to obtain a rebuilt in-memory data structure.

In general, in one aspect, the invention relates to system, comprising: a processor, memory comprising instructions, which when executed by the processor, perform a method, the method comprising: generating a checkpoint from an in-memory data structure maintained in a memory of a management device, wherein the in-memory data structure specifies a first plurality of backups, wherein in each of the plurality of backups is stored in one of a second plurality of backup storage devices managed by the management device, persistently storing the checkpoint, and after restarting the management device, rebuilding the in-memory data structure using the checkpoint to obtain a rebuilt in-memory data structure.

### BRIEF DESCRIPTION OF DRAWINGS

FIG. 1 shows a system in accordance with one or more embodiments of the invention.

FIG. 2 shows a method for updating the in-memory data structure in accordance with one or more embodiments of the invention.

FIG. 3 shows a method for generating the checkpoint in accordance with one or more embodiments of the invention.

FIG. 4 shows a method for rebuilding the in-memory data structure in accordance with one or more embodiments of the invention.

FIG. 5 shows a computing system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

Specific embodiments will now be described with reference to the accompanying figures. In the following description, numerous details are set forth as examples of the invention. It will be understood by those skilled in the art, and having the benefit of this Detailed Description, that one or more embodiments of the present invention may be practiced without these specific details and that numerous variations or modifications may be possible without departing from the scope of the invention. Certain details known to those of ordinary skill in the art may be omitted to avoid obscuring the description.

Further, in the following description of the figures, any component described with regard to a figure, in various embodiments of the invention, may be equivalent to one or more like-named components shown and/or described with regard to any other figure. For brevity, descriptions of these components may not be repeated with regard to each figure. Thus, each and every embodiment of the components of each figure, or that is otherwise described herein, is incorporated by reference and assumed to be optionally present within every other figure and/or embodiment having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure and/or embodiment.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the invention relate to generating and persistently storing snapshots of the current state of the management device along with associated metadata (collectively referred to as checkpoints). More specifically, in various embodiments of the invention the management device includes processes (also referred to as microservices) that interact with the backup storage devices. These processes obtain information from the backup storage devices and store this information in an in-memory data structure. For example, the in-memory data structure may be a global index, where the global index specifies the backups that are currently available for all production hosts that are currently being managed by the management device. The management device maintains the global index in an in-memory data structure in order to permit low latency access to the global index in the event that a production host (or a portion thereof) needs to be recovered. However, in scenarios in which the management device is restarted, the in-memory data structure needs to be rebuilt after the management device is been restarted.

Embodiments of the invention enable an efficient rebuilding of the in-memory data structure by using the most recent (e.g., newest) checkpoint (e.g., a global index checkpoint) to initially populate the in-memory data structure and then obtaining only a minimal set of updates from the backup storage devices in order to bring the in-memory data structures to a current state.

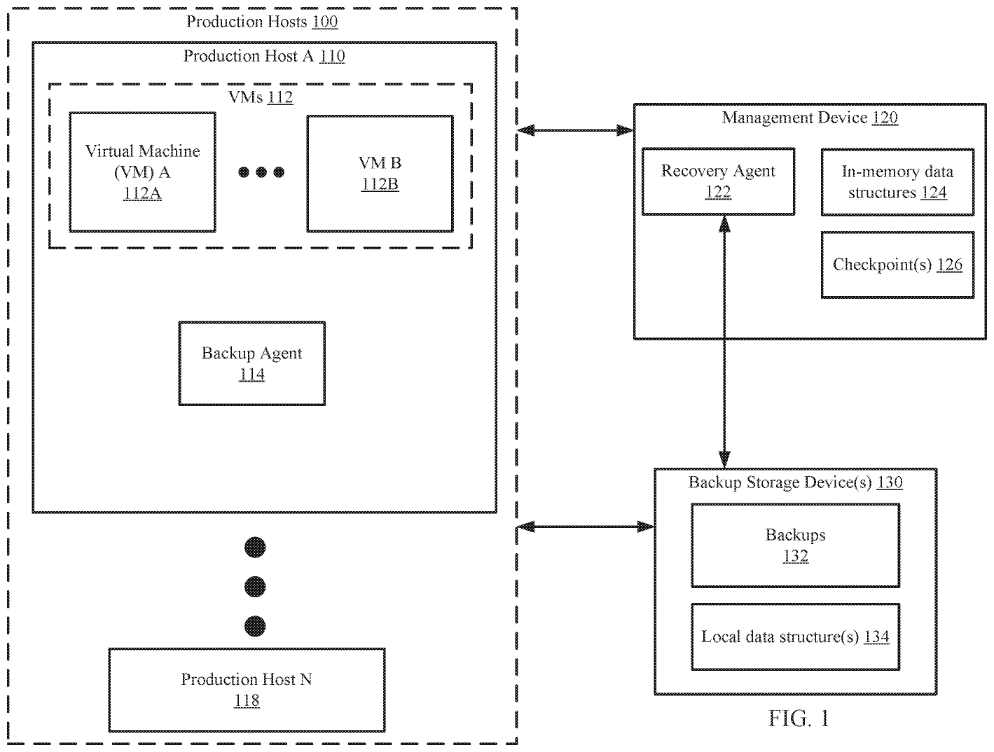

FIG. 1 shows a diagram of a system in accordance with one or more embodiments of the invention. The system includes clients (not shown), one or more production hosts (100), a management device (120), and one or more backup storage devices (130). The system may include additional, fewer, and/or different components without departing from the invention. Each component may be operably connected via any combination of wired and/or wireless connections. Each component illustrated in FIG. 1 is discussed below.

In one or more embodiments of the invention, the clients (not shown) are devices, operated by users, that utilized data generated by the production hosts (100). The clients may send requests to the production hosts (100) to obtain the data to be utilized.

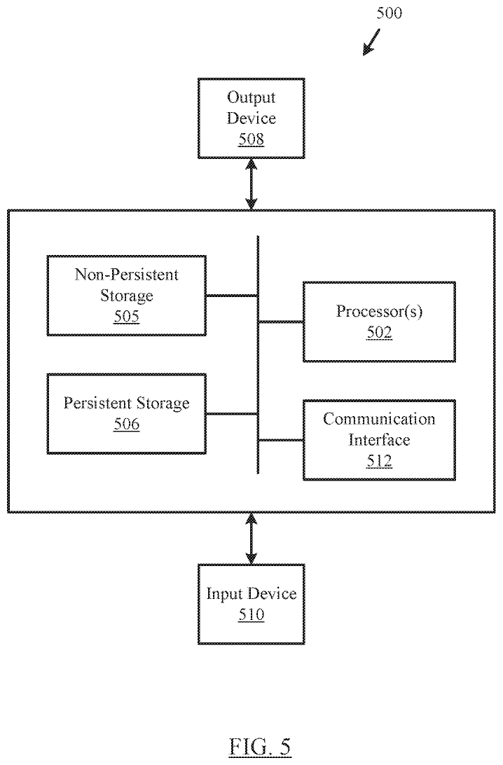

In one or more embodiments of the invention, one or more clients are implemented as computing devices (see e.g., FIG. 5). A computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of a client described throughout this application.

In one or more embodiments of the invention, one or more clients are implemented as logical devices. The logical device may utilize the computing resources of any number of computing devices and thereby provide the functionality of the clients described throughout this application.

In one or more embodiments of the invention, the management device (120) is a device (physical or logical) that interacts, e.g., using one or more microservices, with the backup storage devices to obtain information (e.g., copies of a local index) from the backup storage devices. Examples of microservices include, a discovery microservice that obtains local indexes (discussed below) from backup storage devices, a host discovery microservice which checks and records the status of the registered production hosts, a metadata microservice which checks and records the metadata on the registered production. The management device may include additional or different microservices without departing from the invention.

In one embodiment of the invention, an in-memory data structure (124) includes information that has been collected or generated by one or more microservices executing on the management device. The microservices may obtain the information (e.g., from one or more local data structures (134)), via a push or pull mechanism, from the backup storage devices. Once obtained, the microservices may process the information, which may include modifying the information and/or augmenting the information, and then store the information (which may or may not be modified) in one or more in-memory data structures.

In one or more embodiments of the invention, a snapshot may be taken of the in-memory data structure(s) (or a portion thereof) and persistently stored. The snapshot may be stored with metadata such as when (e.g., data and time) the snapshot was taken and information about which in-memory data structures are included within the snapshot. Additional or different metadata may be stored with the snapshot without departing from the invention. When the snapshot is stored with the aforementioned metadata in the persistent storage, which may be located within or operatively connected to, the management device it is referred to as a checkpoint (126). The management device may maintain an index (not shown) of checkpoints. The index is a data structure, which is persistently stored, and specified which checkpoints are stored in persistent storage.

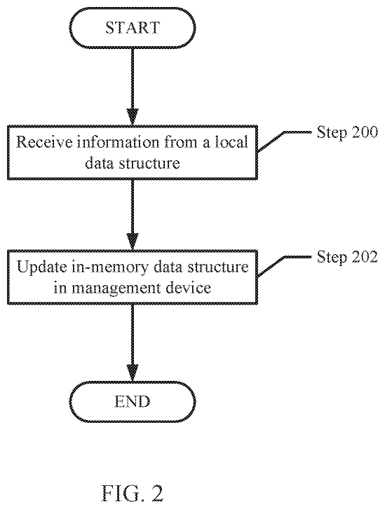

In one or more embodiments of the invention, the management device includes a recovery agent (122) that includes functionality rebuild the in-memory data structures (124). Further, the recovery agent (122) includes functionality to generate and manage the checkpoints (126)). Further, the recovery agent interacts with the production hosts and backup storage devices, as required, to provide information (e.g., from the global index) for recovery purposes (e.g., obtaining a backup for a failed VM or production host). In one or more of embodiments of the invention, the recovery agent (122) is implemented as computer instructions, e.g., computer code, stored on a persistent storage that when executed by a processor of the management device (120) cause the recovery agent to perform the aforementioned functionality as well as any other functionality that is described throughout this application. Additional detail about the operation of the management device and recovery agent is provided below in FIGS. 2-4.

In one or more embodiments of the invention, the management device (120) is implemented as a computing device (see e.g., FIG. 5). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the management device described throughout this application.

In one or more embodiments of the invention, the management device (120) is implemented as a logical device. The logical device may utilize the computing resources of any number of computing devices and thereby provide the functionality of the management device (120) described throughout this application.

In one or more embodiments of the invention, the production hosts (100) host any number of virtual machines (VMs) (112A, 112B). In one or more of embodiments of the invention, the virtual machines (112A, 112B) are implemented as computer instructions, e.g., computer code, stored on a persistent storage (e.g., on the production host (110, 118)) that when executed by a processor(s) of the production host (110, 118) cause the production host (110, 118) to provide the functionality of the virtual machines (112A, 112B) described throughout this application.

In one or more embodiments of the invention, the production host (110, 118) is implemented as a computing device (see e.g., FIG. 5). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the production host (110, 118) described throughout this application.

In one or more embodiments of the invention, the production host (110, 118) is implemented as a logical device. The logical device may utilize the computing resources of any number of computing devices and thereby provide the functionality of the production host (110, 118) described throughout this application.

In one embodiment of the invention, the production hosts may include backup agents (e.g., 114) that include functionality to generate backups and to recover virtual machines (or applications thereon from backups). The generation of the backups and the use of backups to recover a production host or virtual machine, or application executing on a virtual machine may be managed or initiated by the recovery agent (or more generally by the management device). In one or more of embodiments of the invention, the backup agents are implemented as computer instructions, e.g., computer code, stored on a persistent storage that when executed by a processor of the production host (110, 118) cause the backup agents (e.g., 124) to perform the aforementioned functionality as well as any other functionality that is described throughout this application.

In one or more embodiments of the invention, the backup storage device (130) manages the backups of virtual machines hosted by the production hosts (110, 118). In one or more embodiments of the invention, the backup storage device (150) stores backups (132) in persistent storage of the backup storage device or in persistent storage operatively connected to the backup storage device. The backups (132) may be virtual machine backups or backups of portions of a virtual machine. In one or more embodiments of the invention, the virtual machine backups include backups of one or more virtual machines (112A, 112B). A backup may be a data structure that may be used to recover a virtual machine (or a portion thereof) to a previous point in time. The backup may include data of the virtual machine, encrypted data of the virtual machine, metadata that references the data of the virtual machine, and/or other data associated with the virtual machine (or applications executing therein) without departing from the invention.

In one embodiment of the invention, the backup storage device may also include one or more local data structures (134). The local data structures are populated by the processes executing on the backup storage devices. The local data structures may be located in persistent storage, volatile storage, or a combination thereof. The local data structures may be accessible by the microservices executing on the management device, such that the data (or portions thereof) from the local data structures are obtained from the backup storage devices and provided to the management device. In one example, the local data structure may be a local index, where the local index specifies the backups that are currently available for all backup storage device. The local data structure and/or local index may also include additional information such as, backup-type (e.g., full, incremental, etc.), label number of the backup, information about that applications within the backup, information about specific location of the backup, retention time related information that is stored in the backup, backup size, policy related information corresponding to the current backup. Additional and/or different data may be stored in the backup without departing from the invention.

In one or more embodiments of the invention, the backup storage devices (130) are implemented as physical devices. The physical devices may include circuitry. The physical devices may be, for example, a field-programmable gate array, application specific integrated circuit, programmable processor, microcontroller, digital signal processor, or other hardware processor. The physical devices may be adapted to provide the functionality described throughout this application.

The invention is not limited to the architecture shown in FIG. 1 and/or described above.

FIGS. 2-4 show flowcharts in accordance with one or more embodiments of the invention. While the various steps in the flowcharts are presented and described sequentially, one of ordinary skill in the relevant art will appreciate that some or all of the steps may be executed in different orders, may be combined or omitted, and some or all steps may be executed in parallel. In one embodiment of the invention, the steps shown in FIGS. 2-4 may be performed in parallel with any other steps shown in FIGS. 2-4 without departing from the scope of the invention.

FIG. 2 shows a method for updating the in-memory data structure in accordance with one or more embodiments of the invention. The method shown in FIG. 2 may be performed by the management device.

In step 200, information is obtained from a backup storage device. The information may be obtained by a microservice (as discussed above) executing on the management device. In this scenario, the microservice may request the information from the backup storage device and, in response to the request the backup storage device may provide the requested information to the management device.

In step 202, upon receipt of the information from the local device, the microservice processes the information and then updates the in-memory data structure.

The process shown in FIG. 2 may be continuously implemented by the microservice interacting with the various backup storage devices. Further, the process shown in FIG. 2 may be implemented (in parallel or substantially in parallel) by multiple microservices, each of which are interacting with one or more backup storage devices.

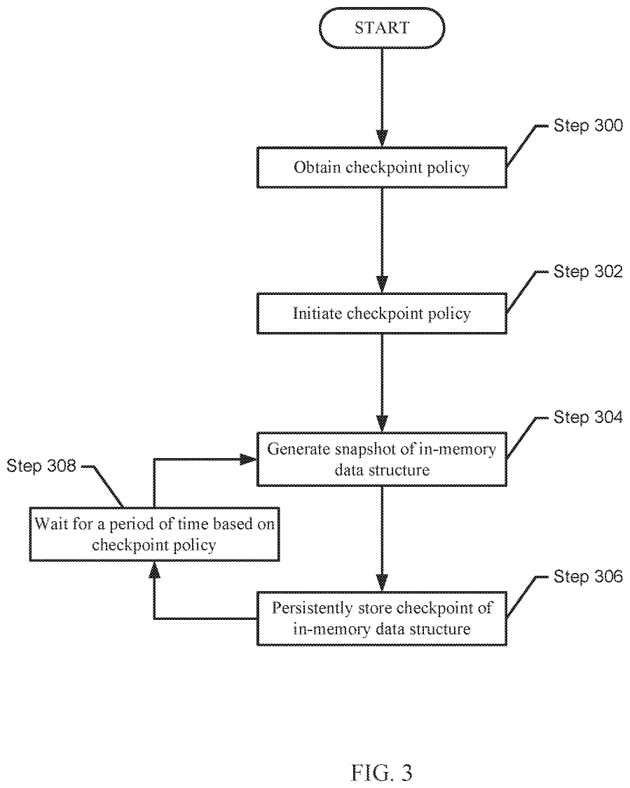

FIG. 3 shows a method for generating a checkpoint in accordance with one or more embodiments of the invention. The method shown in FIG. 3 may be performed by the management device.

In step 300, a checkpoint policy is obtained. The checkpoint policy may specify how often a checkpoint is to be generated and stored in persistent storage. For example, the checkpoint policy may indicate that a checkpoint is to be generated every hour. In another embodiment, the checkpoint policy may specify that a checkpoint is to be generated when a certain amount of information (or data) is received by the management device. In one embodiment of the invention, there may be one checkpoint policy that is implemented by the management device; in another embodiment of the invention, there may be one checkpoint policy for each microservice or a checkpoint policy that is applied to a subset of microservices. The granularity of the checkpoint policy may vary based on the implementation of the invention. For example, a discovery microservice may generate a checkpoint after 10000 entries (e.g., entries from the local index(es)) are obtained. In another example, a checkpoint may be generated for data collected by a host discovery service each every 24 hours.

In step 302, the checkpoint policy(ies) obtained in step 300 are initiated. Initiating the checkpoint policy may include starting to monitor the operation of the microservices and/or the in-memory data structures to determine whether a condition(s) for taking a checkpoint is triggered.

In step 304, an initial snapshot of all (or a portion of the in-memory data structure, as appropriate) may be obtained. The snapshot includes a copy of the current contents of all (or as the case may be, a portion) of the in-memory data structure.

In step 306, the snapshot may be associated with metadata such as the current data and time and information about the specific content in the snapshot. The snapshot may be combined with the aforementioned metadata to generate a checkpoint. The checkpoint may be stored in persistent storage in (or operatively connected to) the management device. The management device may also maintain an index (which may also be persistently stored) that includes the listing of checkpoints that are currently stored in persistent storage.

In step 308, the management device continues to monitor the operation of the microservices and/or the in-memory data structures and waits until a condition in one or more checkpoint policies is satisfied, as which time the process proceeds to step 304.

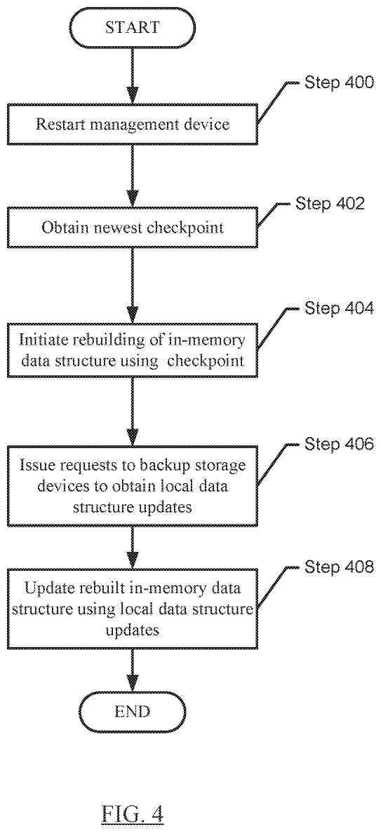

FIG. 4 shows a method for rebuilding the in-memory data structure in accordance with one or more embodiments of the invention. The method shown in FIG. 4 may be performed by the management device.

In step 400, the management device (or a portion thereof) is restarted. The restarting of the management device (or a portion thereof) may result in all or a portion of the in-memory data structure being lost or otherwise removed from the in-memory data structure. For example, if the management device is restarted, the power cycling the occurs when turning off and subsequently turning on the management device results in the contents of the memory (which includes the in-memory data structure) being cleared.

In step 402, once the management device has been restarted, the recovery agent may query the checkpoint index (which is persistently stored) and identify the appropriate checkpoint to obtained. The checkpoint that is identified typically corresponds to the newest checkpoint, i.e., the checkpoint that was stored most recently prior to the restarting of the management device (or portion thereof). The identified checkpoint includes the content of the in-memory data structure (or portion thereof) that is closest to (or the same as) the content of the in-memory data structure as if the management device (or portion thereof) has not been restarted.

In step 404, the recovery agent initiates the rebuilding of the in-memory data structure using the identified checkpoint. The rebuilding of the in-memory data structure may include extracting data from the checkpoint and populating the in-memory data structure with the extracted data.

In step 406, in order to ensure that the in-memory data structure either has the most current content (i.e., the content that it should have had but for the restarting in step 400), the recovery agent may issue requests to the backup storage devices for information stored in their local data structures. In response to the request, the backup storage devices provide updated information to the management device. In one embodiment of the invention, the requests issued by the recovery agent include time stamp information, which is used to limit the amount of information that the backup storage devices need to provide to the management device. In one embodiment of the invention, the microservices (instead of the recovery agent) issue the requests in step 406.

In step 408, the updated information obtained from the backup storage devices is subsequently received and analyzed. The in-memory data structure may be updated based on the analysis of the updated information.

The process shown in FIG. 4 may be performed at each restarting of the management device (or a restarting of a portion thereof).

Though not shown in FIG. 4, once the in-memory data structure has been rebuilt, it will continue to be updated, e.g., in accordance with FIG. 2. Further, in the event that a production host (or a VM executing thereon) needs to be recovered, the management device may use the re-built in-memory data structure to initiate the recovery of the production host (or VM executing thereon). For example, the recovery agent may identify the appropriate backups to use to recovery the production host based on the contents of the re-built in-memory data structure. Once the recovery agent has identified the appropriate backups, it will coordinate the recovery of the production host (or VM executing thereon) with the backup storage device(s) that includes the identified backups.

### Example

The following example is used to illustrate various embodiments of the invention. The example is not intended to limit the scope of the invention.

Turning to the example, consider a scenario in which there are two backup storage devices (BSD A, BSD B) and each maintains a local index (Local Index A, Local Index B) of the backups that they each have stored. A discovery microservice executing on a management device may obtain updates from BSD A and BSD B every hour. The updates from BSD A and BSD B are used to updated a global index (which is maintained in-memory), which lists all backups available across BSD A and BSD B. In this example, the checkpoint policy requires that a checkpoint is obtained every three hours.

Assume that at time T=4 there are two checkpoints stored in the management device—checkpoint 1 (CP 1) with a timestamp T=0 and CP 2 with a timestamp T=3. At T=5, the management device is restarted, as a result the in-memory data structure (i.e., the global index in this example) is cleared from the memory as a result of the restarting. In response, and in accordance with FIG. 4, the recovery agent on the management device obtains CP 2 and uses the contents of CP 2 to re-build the global index. However, the global index after the rebuilding using CP 2 is only current as of T=4. Accordingly, the discovery microservice issues a request to BSD A and BSD B for updates that occurred since T=4. Upon receipt of their responses, the global index may be updated and be current as of T=6. At this point, and per the checkpoint policy, the CP 3 is obtained at T=6.

By using the persistently stored checkpoints to rebuild the global index, the discovery microservice does not need request information from BSD A and BSD B that occurred starting at T=0; rather, the discovery microservice only has to obtain information that was generated and stored in the local indexes of BSD A and BSD B after T=4. As a result, the global index may be rebuilt more efficiently and utilize fewer processing resources on BSD A and BSD B and less network bandwidth between BSD A/BSD B and the management device.

### End of Example

As discussed above, embodiments of the invention may be implemented using computing devices. FIG. 5 shows a diagram of a computing device in accordance with one or more embodiments of the invention. The computing device (500) may include one or more computer processors (502), non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.), a communication interface (512) (e.g., Bluetooth interface, infrared interface, network interface, optical interface, etc.), input devices (510), output devices (508), and numerous other elements (not shown) and functionalities. Each of these components is described below.

In one embodiment of the invention, the computer processor(s) (502) may be an integrated circuit for processing instructions. For example, the computer processor(s) may be one or more cores or micro-cores of a processor. The computing device (500) may also include one or more input devices (510), such as a touchscreen, keyboard, mouse, microphone, touchpad, electronic pen, or any other type of input device. Further, the communication interface (512) may include an integrated circuit for connecting the computing device (500) to a network (not shown) (e.g., a local area network (LAN), a wide area network (WAN) such as the Internet, mobile network, or any other type of network) and/or to another device, such as another computing device.

In one embodiment of the invention, the computing device (500) may include one or more output devices (508), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many different types of computing devices exist, and the aforementioned input and output device(s) may take other forms.

One or more embodiments of the invention may be implemented using instructions executed by one or more processors of the data management device. Further, such instructions may correspond to computer readable instructions that are stored on one or more non-transitory computer readable mediums.

One or more embodiments of the invention may improve the operation of one or more computing devices. More specifically, embodiments of the invention may improve the recovery of the management device in scenarios in which the management device needs to be restarted.

Thus, embodiments of the invention may address the inefficient regeneration of the in-memory global index due to a restarting of the management device. This problem arises due to the technological nature of the environment in which the management device maintains an in-memory data structure of the global index to enable the backup storage systems and production hosts to efficiently access the global index; however, if the management device restarts then the in-memory data structure needs to be rebuilt.

The problems discussed above should be understood as being examples of problems solved by embodiments of the invention disclosed herein and the invention should not be limited to solving the same/similar problems. The disclosed invention is broadly applicable to address a range of problems beyond those discussed herein.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for managing backup operations, the method comprising:
generating a checkpoint from an in-memory data structure maintained in a memory of a management device, wherein the in-memory data structure specifies a first plurality of backups, wherein in each of the plurality of backups is stored in one of a second plurality of backup storage devices managed by the management device;
persistently storing the checkpoint; and
after restarting the management device, rebuilding the in-memory data structure using the checkpoint to obtain a rebuilt in-memory data structure.

2. The method of claim 1, further comprising:
obtaining a checkpoint policy,
wherein the checkpoint is generated in accordance with the checkpoint policy.

3. The method of claim 1, wherein rebuilding the in-memory data structure using the checkpoint comprises:
obtaining a local index from at least of one of the plurality of backup storage devices, wherein the local index is associated with a first timestamp that is newer than a second timestamp that is associated with the checkpoint.

4. The method of claim 1, further comprising:
receiving a local index from one of the plurality of backup storage devices, wherein the local index specifies a third plurality of backups stored on the one of the plurality of backup storage devices;
updating the in-memory data structure using the local index.

5. The method of claim 1, further comprising:
after rebuilding the in-memory data structure, receiving a local index from one of the plurality of backup storage devices, wherein the local index specifies a third plurality of backups stored on the one of the plurality of backup storage devices;
updating the rebuilt in-memory data structure using the local index to obtain an updated in-memory structure.

6. The method of claim 5, further comprising:
initiating a recovery of a production host operatively connected to the management device using the updated in-memory data structure.

7. The method of claim 1, wherein the checkpoint policy specifies a schedule, wherein the checkpoint is generated based on the schedule.

8. A non-transitory computer readable medium comprising computer readable program code, which when executed by a computer processor enables the computer processor to perform a method for storing data, the method comprising:
generating a checkpoint from an in-memory data structure maintained in a memory of a management device, wherein the in-memory data structure specifies a first plurality of backups, wherein in each of the plurality of backups is stored in one of a second plurality of backup storage devices managed by the management device;
persistently storing the checkpoint; and
after restarting the management device, rebuilding the in-memory data structure using the checkpoint to obtain a rebuilt in-memory data structure.

9. The non-transitory computer readable medium of claim 8, wherein the method further comprises:
obtaining a checkpoint policy,
wherein the checkpoint is generated in accordance with the checkpoint policy.

10. The non-transitory computer readable medium of claim 8, wherein rebuilding the in-memory data structure using the checkpoint comprises:
obtaining a local index from at least of one of the plurality of backup storage devices, wherein the local index is associated with a first timestamp that is newer than a second timestamp that is associated with the checkpoint.

11. The non-transitory computer readable medium of claim 8, wherein the method further comprises:
receiving a local index from one of the plurality of backup storage devices, wherein the local index specifies a third plurality of backups stored on the one of the plurality of backup storage devices;
updating the in-memory data structure using the local index.

12. The non-transitory computer readable medium of claim 8, wherein the method further comprises:
after rebuilding the in-memory data structure, receiving a local index from one of the plurality of backup storage devices, wherein the local index specifies a third plurality of backups stored on the one of the plurality of backup storage devices;
updating the rebuilt in-memory data structure using the local index to obtain an updated in-memory data structure.

13. The non-transitory computer readable medium of claim 12, wherein the method further comprises:
initiating a recovery of a production host operatively connected to the management device using the updated in-memory data structure.

14. The non-transitory computer readable medium of claim 8, wherein the checkpoint policy specifies a schedule, wherein the checkpoint is generated based on the schedule.

15. A system, comprising:
a processor;
memory comprising instructions, which when executed by the processor, perform a method, the method comprising:
generating a checkpoint from an in-memory data structure maintained in a memory of a management device, wherein the in-memory data structure specifies a first plurality of backups, wherein in each of the plurality of backups is stored in one of a second plurality of backup storage devices managed by the management device;
persistently storing the checkpoint; and
after restarting the management device, rebuilding the in-memory data structure using the checkpoint to obtain a rebuilt in-memory data structure.

16. The system of claim 15, wherein the method further comprises:
obtaining a checkpoint policy,
wherein the checkpoint is generated in accordance with the checkpoint policy.

17. The system of claim 15, wherein rebuilding the in-memory data structure using the checkpoint comprises:
obtaining a local index from at least of one of the plurality of backup storage devices, wherein the local index is associated with a first timestamp that is newer than a second timestamp that is associated with the checkpoint.

18. The system of claim 15, wherein the method further comprises:
receiving a local index from one of the plurality of backup storage devices, wherein the local index specifies a third plurality of backups stored on the one of the plurality of backup storage devices;
updating the in-memory data structure using the local index.

19. The system of claim 15, wherein the method further comprises:
after rebuilding the in-memory data structure, receiving a local index from one of the plurality of backup storage devices, wherein the local index specifies a third plurality of backups stored on the one of the plurality of backup storage devices;
updating the rebuilt in-memory data structure using the local index to obtain an updated in-memory data structure.

20. The system of claim 19, wherein the method further comprises:
initiating a recovery of a production host operatively connected to the management device using the updated in-memory data structure.
